(19) United States
(12) Patent Application Publication
(10) Pub. No.: US 2002/0174016 A1
(43) Pub. Date: Nov. 21, 2002

(54) Multiple accounts and purposes card method and system

(76) Inventor: Vincent Cuervo, Coral Gables, FL (US)

Correspondence Address: Dr. Vincent Cuervo, 1545 Miller Road, Coral Gables, FL, 33146-2309, US

(21) Appl. No.: 10/114,522

(22) Filed: Apr. 2, 2002

Related U.S. Application Data
(63) Continuation-in-part of application No. 09/894,581, filed on Jun. 28, 2001.
Application No. 09/894,581 is a continuation-in-part of application No. 09/524,496, filed on Mar. 13, 2000, now Pat. No. 6,405,182.
Application No. 09/524,496 is a continuation-in-part of application No. 09/207,854, filed on Dec. 8, 1998.
Application No. 09/207,854 is a continuation-in-part of application No. 08/877,006, filed on Jun. 16, 1997, now abandoned.

(51) Int. Cl. G06F 17/60

(52) U.S. Cl. 705/16; 705/41

(57) ABSTRACT

An invention relating to a multiple accounts and purposes single card with a choice to be used in one or as combination of operative different accounts available, as a prepaid debit, a bank, an ATM, a “Smart Card”, a Stored Value, a Gift, a Check, a Cash, a Debit or a Credit card. One versatile rechargeable card to be sold, purchased, replaceable if lost, activated and issued carrying any, some or all of the above features.

It differs from any other presently available cards, for adding to their present tracking information. As a credit card, or a Gift card, or purchaser may ad the prepaid debit card feature for a child in college at a remote city or country, adding control of the expenditures of the user, while using the same serial identifying or link number card in a different function(s) like including electronic mail or wireless telephone service, notification of timely usage of the card, amount charged and where was used. Another practical use involves the distribution to traveling salespersons authorizing geographical specific use, allowing others the use of same functions or others in the card in a different area.

A card loaded with different available features and functions able to be purchase using cash, or with charges to any other bankcard, checking or savings account as a deposit, an allowance, rebate, gift or reward. A card capable of money transfers, funds card-to-card, person-to-person through ATMs, POS, online, offline, or through wireless services.

### RELATED U.S. APPLICATION DATA

The present application is a continuation-in-part of pending U.S. patent application Ser. No. 09/894,581 filed on Jun. 28, 2001, which in turn is a continuation-in-part of patent pending application Ser. No. 09/524,496 filed Mar. 13, 2000 now as of Feb. 19, 2002 a U.S. Patent Allowed, which in turn is a continuation-in-part of patent pending application Ser. No. 09/207,1854 filed Dec. 8, 1998 which in turn is a continuation-in-part of U.S. Pat. No. 6,105,009 issued on Aug. 15, 2000, which in turn is a continuation-in-part of abandoned application Ser. No. 08/877,006 filed on Jun. 16, 1997 which are incorporated by reference.

### TECHNICAL FIELD

The present invention relates to a multiple accounts and purposes single card method and system operative through computerized terminals, such as automated teller machines (ATM), point-of-sale terminals (POS), networks, wireless services, computers, online, and telephone lines.

### BACKGROUND OF THE INVENTION

1. Description of the Related Art

Applicant believes that there are not issued patents, published or unpublished patent applications pending describing a subject matter close to the novel features of the present invention. Information regarding previous possible art learn regarding it, will be forward through information disclosure statements.

2. Field of the Invention

An invention relating to a multiple accounts and purposes single card to be used, operated and offered as a single card with a prepaid, a bank, an ATM, a “Smart Card”, a Stored Value, a Gift, a Check, a Cash, a Debit or a Credit card, one or several in combination with it. It will be available and purchase at certain retailers, banks, through toll free numbers, and direct mail. A versatile card to be sold, issued, dispensed and activated as a prepaid stored value with a desired amount that sets the spending currency limit using the prepaid card functionality or a fixed line of credit, easily loadable and re-loadable with funds from a checking or savings account or from an existing credit card like MasterCard, VISA, AMEX, or DISCOVER. Available as a prepaid card with or without previous bank account link, with fill optional facility functions of a full bank credit card capable of been uses at a merchant just like any other credit card.

It differs from debit, credit, gift, cash, bank, Smart, ATM or any other presently available cards, for adding to their present usage and tracking information. Additionally, the resulting cards affixed data and instructions include conditions for the validation availability of those funds or line of credit, such as, period of time between use of withdrawals, day of the week, amounts or any other constrains the purchaser of the card desires in order to match the particular circumstances of the case. For instances, a debit card purchaser may obtain a debit card for a child in college in a remote city and desires to control the expenditures of the user, while using the same serial identifying or link number card in a different function(s), and the inclusion of his or her e-mail or wireless phone service, and be notified every time the card is used and the establishment where the card was used. Other uses involve the distribution of the cards to traveling salespersons who are authorized to use the card in a particular territory only, while other employees made use of another of the card functions.

Multiple accounts with different functions and features all in one card, able to load money from a debit or credit card, or from a checking or savings account as a deposit, an allowance, a rebate, a gift or a reward. Use to transfer of money from card-to-card or person-to-person through ATM (see U.S. Pat. No. 6,105,009, and U.S. Patent Pending application Ser. No. #9/524,496, now Patent Allowed since Feb. 19, 2002) by using stored value, prepaid, gift cards and others, which after loaded the sender informs the recipient amount stored, PIN or password number to be used by the recipient as card to access and retrieve the transferred finds from the ATM.

The card strive in its ability to be used in various different manners and account varieties:

i) as a prepaid stored value card with built-in spending limit permitting to access pre-loaded cash from an account you fund with your funding source(s). As it is used, charges reduce the balance in the original stored value loaded, which it increases when more cash is loaded; ii) as a gift or stored value card carrying a limited amount of cash and spending power, it may be re-loadable, if not it becomes useless as funds are exhausted. The Gift card with limited stored value frequently given away by merchant or retailers or service providers offering discounts, cash rebates, rewards or allowances as marketing promotions; iii) as bank or check card, also known as a network card. Charges from merchandise of services purchased debit a bank or institution checking of savings account, the charges reducing existing balances available in that account, if sufficient; iiii) as a credit card with no personal identifying number input required when purchasing services or merchandise, but PIN required for ATM's usage, with all credit card requirements as approved or pre-approved line of credit, a credit report if necessary, detailed application submission, interest charges, etc.; iiiii) a money transfer card-to-card through ATMs (U.S. Pat. No. 6,105,009) or other computerized terminal facility.

The multiple accounts purposes card carried in one single versatile card will easily be sold, issued, dispensed, and in most cases activated when purchased, prepaid or pre-loaded, loadable and re-loadable with cash or from funds in a debit or credit card, or from a checking or savings account, deposits, as an allowance, a rebate, a gift, rebates and or rewards, at any time and anyplace where are computerized terminals, wireless services, user's home telephone. A card that permits approval and/or activation at banks, retail stores, financial institutions and online, providing that the requested data supplied is verified and receives acceptance through wireless services, online, or telephone lines, and is activated by recipient when received.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a Method and System applicable for a more efficient and versatile card, its distribution, issuance, purchasing and dispensing.

It is another object of this invention to provide the user of an expedite and less expensive way of delivering to the recipient one single card able to fulfill the same all functions that presently several cards are needed to obtain the same number of accomplishments.

It is another object of this invention to procure speed processing and safety activation, issue, dispensing and readiness for it's usage of a card with multiple accounts and purposes, and versatile functions and benefits in one single card only in opposite to a number of cards for each different desired function or purpose.

It is another object of this invention to provide a system that permits acquiring such cards from widely available computerized terminal assemblies such as point-of-sale terminals,(see, now U.S. Patent allowed, application Ser No. #09/524,496), or ATM (U.S. Pat. No. 6,105,009), online electronic commerce (see patent pending application Ser. No. 09/207,854), terminals, at merchant outlets, banks, a toll-free phone number, and direct mail, using cash, debit and/or credit cards, check cards, cash cards, bank cards, or ATM cards.

It is yet another object of the present invention to allow the users the choice of a confidential Personal Identification Number (“PIN”) or Password(s), inhibiting unauthorized use of the card.

It is another object of this invention to provide a system that permits a user to obtain more than one card associated with the same identifying serial number, or linked to the same number, for accepting deposits and withdrawals to readily affect transfers of finds to remote locations, including foreign countries and the transfer directly between and among each other debit and credit cards creating the card-to-card or person-to-person payments and or transfers.

It is yet another object of this invention to allow several members of a family or a work place employees the use of cards with the same identifying serial number, or linked to the same number having each user different allowed or desire functions from the other(s) users of the same serial number.

Further objects of the invention will be brought out in the following part of the specifications, wherein detailed description is for the purpose of fully disclosing the invention without placing limitations thereon.

### BRIEF DESCRIPTION OF THE DRAWINGS

With the above and other related objects in view, the invention consist in the details of combining electronic transactions which will be more fully understood from the following description, when read in conjunction with the accompanying drawings in which:

FIG. 1 represents a block of the system hardware used in one of the preferred embodiments for the present invention, and steps requiring the validation and activation after dispensing the credit or debit card.

FIG. 2 is a flow chart summarizing the process steps followed in transaction using the multiple functions and versatility.

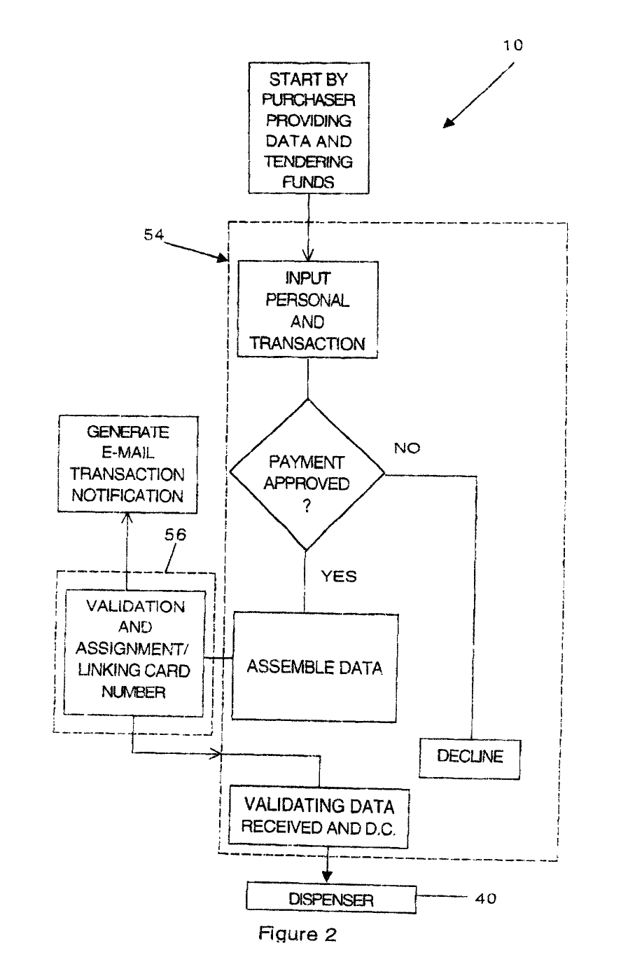

### DETAILED DESCRIPTION OF THE PREFERRED EMBODIMENT

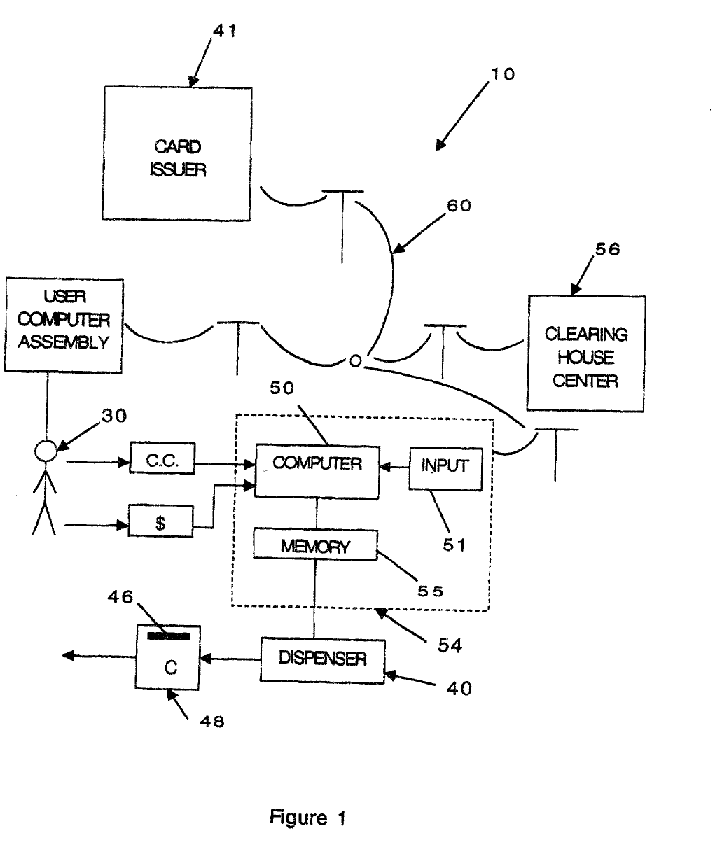

Referring now to the drawings, where the present invention is generally referred to with numeral 10 it can be observed that it basically includes computerized terminals 54 as point-of-sale (POS) for controlling the issuance of cards 48. Terminal 54 can also be implemented with other computerized assemblies, such as an ATM (automated teller machines), wireless services and or telephone lines. Terminals 54 in this application is understood to be the location where the transactions involving the sale, acquisition, loading or future re-loadings of card 48 takes place. Terminal 54 includes input assembly 51 basically comprising a keypad with numbers, letters, names, graphics, magnetic card reader, embedded microchips cards-wallet-size card readers, symbols, all integrated in terminal 54 in preferred embodiment. The purchaser is represented with numeral 30 in FIG. 1. A merchant or dispenser, of the card is referenced with numeral 40. Dispenser 40 can be implemented with an automatic mechanism that dispenses cards 48 upon validation or activation by terminal 54 or merely a person who releases cards 48 upon receiving the validation signal. The entity issuing card 48 is card issuer numeral 41 and is considered the operator of card system 10. Computerized clearing house 56 is connected through telecommunications network 60 to terminals 54 and the internet in general. For the purposes of this application, purchaser 30 will be deemed a card purchaser or holder. Dispenser 40 is the merchant or the entity or place selling the card and an issuer will be the entity, bank, or financial institution issuing the card. Dispenser 40 has cards with a digital storage member 46, typically a magnetic strip and the “smart” embedded microchips card readers, wherein a unique identifying serial number has been recorded and identifies card 48. Use of member 46 and card 48 is intended to facilitate the use of system 10. Terminal 54 has the necessary input and output hardware and software for performing different transactions such as card charges, card credits, computer assembly 50 and associated storage assembly 55.

As shown in FIG. 1, card purchaser 30 initiates the process when approaching a merchant or dispenser 40 offering the sale of the card at counter through terminals 54. Different purpose cards variety and different prepaid amounts can be available or a particular amount requested. Once purchaser decides the card variety and prepaid amount desired for the card to be purchased a menu or series of questions is required to be answered depending on the conditions purchaser 30 wants to impose for withdrawing, transferring, loading funds and how much security in the use of the card is desired. Government regulations may require the disclosure of purchaser's Particulars, namely, name, address, and the social security number, if foreigner the country's legal identification, for cards funded over a predetermined limit. Purchaser 30 (or the card holder) validates the funds in the card for future use by entering a confidential number and or letters. The personal identification numbers (PIN) or passwords is preferably selected by the purchaser without disclosing it to the merchant. Additional security information, such as a purchaser mother's maiden name, the name of the first high school attended, can be required for future use if the card is lost or stolen. Issuer 41 determines the amount of information it might require, or make optional, leaving latitude and flexibility for the purchaser as to how much information wants to disclose or security safeguards placed. The more information he/she enters the more secure the card will be. The card will carry as many personalized confidential information or passwords numbers as many accounts purposes or variety of features become or are operative in the card allowing the purchaser to have the ability to design the kind, terms and conditions of the card to fit his or her objectives. Purchaser 30 can then transmit the card serial number needed PIN or password(s) number for the particular design objective to a designated user with more or less restrictions (as the first PIN or password number) for the card functions. The information entered by the card purchaser is stored in storage assembly 55 associated with computer assembly 50 for subsequent future transmission to clearing house 56, as shown in FIG. 1.

The following step pertains to entering information about transaction such as the amount to be deposited (to fund the card if a prepaid debit card), the method of payment (cash, bank card, etc.), if a bank debit card the checking or savings account to be link to. When a cash transaction, the merchant collects the cash as if it is a routine transaction but entering this card type code number, the identification number of the card being purchased. At this time, terminal 54 transmit the block of information that has been assembled to clearing house assembly 56 that in turn issues a validating signal back to the terminal 54.

Purchase 30 obtains a debit card for the amount he or she has prepaid with or without a small processing fee, that amount is credited, and the card is dispensed by terminal 54 this time as a credit charge of the prepaid amount.

More than one card can be dispensed to the same purchaser and the serial numbers linked to each other. Software instructions and data included in clearing house 56 will make them look as if they were only one number. Alternatively, the two, or additional, cards are given the same serial numbers and selected password numbers identifying the purpose and different variety features available and the one(s) approved. In this manner, a card purchaser may give only one card to several others (traveling salesmen, child in college away from home, etc.) but each one with a different feature(s) approved, each will be able to use the card in accordance with purpose of the card and feature(s) approved in the card, and under other additional restrictions associated with the PIN or password(s) given to them. Purchaser 30 or authorized users can then, if a prepaid debit card, reload the card for remote usage by other, realize card to card transfer of funds, money transfer, person-to-person payments, thus effectively constituting an instantaneous transfer of money or funds (U.S. Patent Pending application Ser. No. # 9/524,496, Patent Allowed on Feb. 19, 2002).

The particulars of the user and the transaction, as well as the serial number(s) of the card(s) being dispensed, are assembled in a predetermined manner and forwarded through network 60 to clearing house 56, and through the existing facilities provided by the computerized terminals 54. Additionally, purchaser 30 may include in his or her particulars, an electronic mail address, a wireless telephone number to received information about each transaction in real time. Software in clearing house 56 is programmed to forward the particulars of each transaction (date, time, amount, establishment where purchase took place, etc.) to user or users. In this manner, purchaser 30 or any designated person, can track, in real time, the transactions involving card 48, as they occur.

Industrial Applicability

It is apparent from the previous paragraphs than an improvement of a type of such multiple accounts and purposes cards system through facilities with available computerized terminals is quite desirable to permit a user to acquire such cards also from widely available terminals accepting cash, debit and/or credit cards, check cards, POS, or ATM cards requiring a minimum of paperwork, maintenance and financial disclosure from a card purchase that would have a variety of other card's features in just one single card.

This system offers a card with multiple accounts and purposes with a variety of versatile options is quite desirable for permitting a user to obtain more than one card with the same identifying serial number for accepting deposits and withdrawals to readily effect transfers of funds to remote locations, including foreign countries, able to transfer money between each other's cards, person-to-person payments, and several passwords or personal identification numbers permitting users to the main one, all or only two or more of the card variety of features.

Additionally, a user can design the terms and conditions for using finds loaded in the card as well as selectively providing real time tracking information to the users and or designees.

What is claimed is:

1. A method and system for the sale, dispensing or delivering validating and activating a multiple accounts and purposes versatile single card, credit or debit card, the magnetic-only variety cards and or the “Smart” cards-wallet-size electronic payment cards with embedded microchips, with or without an attached or associated bank savings account opened by the issuing bank, comprising:
A) A plurality of computerized terminals as on site point-of-sale (POS), “Smart” cards-wallet-size electronic payment cards with embedded microchips or Smart cards readers, and automated teller machines (ATM) located at participating banks, merchant store and service providers, authorized entity or an issuing bank, including first computer means with associated first storage means that further includes input and output means for entering data from merchant, and from purchaser pertaining to him or her, the issuing bank and the particulars of the transaction in said first storage means, said first input means includes a keypad assembly and further including means for funds validation and the use of the card through said input means so that a line of credit is computed by first computer means and storage in said first storage means with a validation signal and a block of data is assembled including the option of a new savings account opening and readiness for transmission;
B) Means for dispensing or delivering an issue a credit or debit card for each transaction, and each of said cards including means for storing a unique identification numbers, personal identification number, login IDs, and/or passwords, said cards being dispensed and or delivered by hand or through computerized terminals and validated only after a first predetermined number of conditions have been met and said validation signal is received from the issuer.
C) A remotely located computerized clearing house assembly, including second computer means, second input and output means for receiving and sending said block of information so that the line of credit, the prepaid stored value amount, or the bank account affixed to the debit card to withdraw from authorization, to the issuer or pre-approved by the issuer is entered for each said unique identification numbers; and
D) network means for connecting said computerized assembly to said clearing house assembly.

2. The system set forth in claim 1, wherein the instructions and data in said second means permit an issuer to offer user to link more than one said identification numbers of said card to one line of credit or loaded stored value, or the check or saving bank account selected and thereby permitting more than one user to simultaneously to access said credit line or storage value, when using the magnetic black stripe variety card or the “smart” cards-wallet-size electronic payment cards with embedded microchips at new card readers point of sale new terminals.

3. The system set forth in claim 2 wherein the instructions and data in said second means permit an issuer to affect the line of credit or stored value of the card users upon occurrence of a second predetermined conditions.

4. The system set forth in claim 3 wherein said second predetermined conditions includes processing a versatile variety of features permits the card users to individually or commonly have access through out personal identification numbers, passwords.

5. The system set forth in claim 4 wherein said second predetermined conditions includes the passage of time with unused balances.

6. The system set forth in claim 5 wherein the card users can send and accept deposits and withdrawals to readily affect transfers of funds to remote locations, including foreign countries, and the transfer directly between and among each other debit or credit cards creating the person-to-person payments and transfers through the use of linked debit cards over a network of remotely distributed computerized assemblies.

7. The system set forth in claim 6 wherein includes the use of said cards in predetermined geographic locations.

8. The system set forth in claim 7 wherein said line of credit, store value, prepaid amount, or pre-approved line of credit, is calculated by issuer in one or more pre-selected foreign currencies.

9. The system set forth in claim 8 wherein a predetermined number of incentives are added to said card line of credit or stored value, selectively, upon occurrence of said second number of predetermined conditions.

10. The system set forth in claim 1 wherein said second storage means further includes instructions and data for transmitting to electronic mail addresses, computers, and or wireless services a predetermined amount of information every time a transaction take place involving the card identification number or password.

11. The system set forth in claim 10 wherein said second storage means further includes instructions and data for accepting a third number of predetermined conditions before the said transmissions to said predetermined electronic mail addresses, computer or wireless services occur.

12. The system set forth in claim 11 wherein the instructions and data in said second storage means permits a user to link more than one said identification or password numbers to said card to one line of credit or prepaid stored value thereby permitting more than one user to simultaneously access said credit line or stored value, as well as permitting the use of all, a predetermined number of them, or only one of the versatile variety of features in the card.

13. The system set forth in claim 12 wherein the instructions and data in said second storage means permit the card user to affect all, few, or only one of the variety of features in the card permitting the issuer of said cards to affect the line of credit or stored value upon the occurrence of a second number of predetermined conditions.

14. The system set forth in claim 1 wherein said block of information includes more than one personal identification or password number and a respective set of limitations associated with each of said personal identification or password numbers for the withdrawal or transfer of funds.

15. The system set forth in claim 14 wherein permits the choice of using the said card only as: as a credit card; as a debit card with a checking or savings account linked; as a prepaid debit card with no previous bank association or links; as a gift card with a limited amount of stored value; as a Smart Card; as a bank card; as an ATM card, or as a Cash card, or using the said card with several of the variety card's multiple purpose features available upon occurrence of predetermined conditions.

16. The system set forth in claim 15 wherein said second number of predetermined conditions includes the passage of time with unused balances.

17. The system set forth in claim 16 wherein users can send and receive funds, accept deposits and withdrawals to readily affect transfers of funds to remote locations, including foreign countries, and in one or more pre-selected foreign currencies, and the transfer directly between and among each other debit and credit cards creating the person-to-person payments and or transfers through the use of linked debit or credit cards.

18. The system set forth in claim 17 wherein a predetermined number of incentives are added to said line of credit, selectively, upon the occurrence of said number of predetermined conditions.
